(19) United States
(12) Patent Application Publication
(10) Pub. No.: US 2013/0226737 A1
(43) Pub. Date: Aug. 29, 2013

(54) SYSTEMS AND METHODS FOR PROVIDING PRODUCT INFORMATION

(71) Applicant: Anthony Milostic, Rosehill, NSW (AU)

(72) Inventor: Anthony Milostic, Rosehill, NSW (AU)

(73) Assignee: JAMES HARDIE TECHNOLOGY LIMITED, Dublin 2 (IE)

(21) Appl. No.: 13/812,848

(22) PCT Filed: Jul. 28, 2011
(86) PCT No.: PCT/AU2011/000947

§ 371 Date: May 3, 2013

(30) Foreign Application Priority Data
Jul. 29, 2010 (AU) 2010903410

(51) Int. Cl. G06Q 30/06; G06Q 50/08

(52) U.S. Cl. CPC G06Q 30/0631; G06Q 50/08
USPC 705/26.63

(57) ABSTRACT

Described herein are systems and methods for providing product information. By way of example, embodiments include computer implemented technologies for delivering information related to building and construction products. Embodiments of the invention have been particularly developed for providing users with access to information including, but not limited to, the likes of fire/acoustic rating information, environmental rating information, and warranty information. Whilst some embodiments will be described herein with particular reference to that application, it will be appreciated that the invention is not limited to such a field of use, and is applicable in broader contexts.

### FIELD OF THE INVENTION

The present invention relates to systems and methods for providing product information. By way of example, embodiments include computer implemented technologies for delivering information related to building and construction products. Embodiments of the invention have been particularly developed for providing users with access to information including, but not limited to, the likes of fire/acoustic rating information, environmental rating information, and warranty information. Whilst some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In the context of building design and construction, selecting an appropriate product or products for a particular project is a complex task. This is exacerbated by a wide range of consideration factors, including fire ratings, acoustic ratings, warranty factors and the like.

### SUMMARY OF THE INVENTION

It is an object of the present invention to overcome or ameliorate at least one of the disadvantages of the prior art, or to provide a useful alternative.

One embodiment provides a computer implemented method for providing product information, the method including the steps of:

providing an interface for receiving data indicative of a set of physical parameters for a structural assembly, and data indicative of one or more operational requirements for that structural assembly;

querying a repository of product information thereby to identify a building solution satisfying the set of physical parameters and one or more operational requirements for that structural assembly; and

providing output for allowing the display of a report indicative of the building solution.

One embodiment provides a method including:

for one or more of the physical parameters, identifying image data for displaying a representation of a structural assembly having those physical parameters; and

providing output for allowing the display of an image based on that image data via the interface.

One embodiment provides a method wherein the structural assembly includes a wall.

One embodiment provides a method wherein the set of physical parameters includes any one or more of framing arrangement, wall application, and presence of wall insulation.

One embodiment provides a method wherein the one or more operational requirements include either or both of fire rating requirements and acoustic rating requirements.

One embodiment provides a method wherein the interface provides functionality to request an acoustic modelling report.

One embodiment provides a method wherein the interface provides functionality to request a fire rating report.

One embodiment provides a method wherein the building solution includes a specified set of wall components.

One embodiment provides a method wherein the report is indicative of characteristics of a wall constructed using the specified set of wall components.

One embodiment provides a method wherein the report is displayed via the interface.

One embodiment provides a computer implemented method for providing product information, the method including the steps of:

providing an interface for receiving data indicative of one or more user-selected construction products;

querying a repository of product information thereby to identify rating data for the one or more user-selected construction products based on a predetermined environmental rating protocol; and

providing output for allowing the display of a report indicative of the rating data.

One embodiment provides a method wherein the predetermined environmental rating protocol includes one or more standards within the Green Star protocol. However, it will be appreciated that other protocols may be used, for example protocols recognized in a jurisdiction of interest (such as a regional/local/national protocol or standard).

One embodiment provides a method wherein the interface received data indicative of a user-selected standard within the Green Star protocol. Again, it will be appreciated that other protocols may be used, for example protocols recognized in a jurisdiction of interest (such as a regional/local/national protocol or standard).

One embodiment provides a method wherein the method includes estimating a number of credit points for each of the user selected products and the report is indicative of ratings calculations for the one or more products.

One embodiment provides a method wherein the one or more user-selected construction products fall into any one or more of the following categories: cladding, trim, weatherboard, façade, paints, coatings, flooring, underlay, and linings.

One embodiment provides a computer implemented method for providing product information, the method including the steps of:

providing an interface for receiving data indicative of one or more user-selected construction products, and data indicative of a user-nominated project using the one or more user-selected construction products;

querying a repository of product information thereby to identify warranty data for the one or more user-selected construction products; and

providing output for allowing the display of a report indicative warranty information for the user-nominated project.

One embodiment provides a method wherein the one or more user-selected construction products fall into any one or more of the following categories: cladding, trim, weatherboard, façade, paints, coatings, flooring, underlay, eaves, joining compounds, ducting, fencing and linings.

One embodiment provides a method wherein the user-nominated project is described by one or more of a project name, address, builder, installer and purchaser.

One embodiment provides a method wherein the report includes one or more certifications to be verified by one or more of a builder and an installer.

One embodiment provides a computer implemented method for providing product information, the method including the steps of:

providing an interface for receiving data indicative of a product category;

querying a repository of product information thereby to identify fire-related product information; and

providing output for allowing the display of information regarding products and construction advice in light of on fire-rating considerations.

One embodiment provides a method wherein the information for display includes diagrammatic specifications for the installation of a predetermined set of products.

One embodiment provides a computer implemented method for providing product information, the method including the steps of:

providing an interface for receiving data indicative of user-selected a floor finish and a user-selected floor ceiling;

querying a repository of product information thereby to identify fire rating information and/or acoustic rating information for the combination of the user-selected floor finish and user-selected floor ceiling; and

providing output for allowing the display of a report indicative of the fire rating information and/or acoustic rating information for the combination of the user-selected floor finish and user-selected floor ceiling.

One embodiment provides a method wherein the method applies to both fire rating information and acoustic rating information.

One embodiment provides a method wherein the method applies to only one of fire rating information and acoustic rating information.

One embodiment provides a method including:

identifying image data for displaying a representation of a floor system using the user-selected floor finish and user-selected floor ceiling; and

providing output for allowing the display of an image based on that image data via the interface.

One embodiment provides a computer implemented method for providing product information, the method including the steps of:

providing an interface for receiving data indicative of:

(i) a set of physical parameters for a structural assembly; and

(ii) one or more operational requirements for that wall, wherein the one or more operational requirements include either or both of fire rating requirements and acoustic rating requirements;

querying a repository of product information thereby to identify a building solution, including a specified set of construction components, which satisfies the set of physical parameters and one or more operational requirements for the structural assembly; and

providing output for allowing the display of a report indicative of the building solution.

The term “structural assembly” is used to describe an assembly defined by some or all of a structural support (e.g. framing), a foundation (concrete slab, brick piers, strip footings, etc), functional inclusions (building paper, thermal/acoustic insulation), cladding products, openings (such as windows or doors), and finishings (such as weatherproofing, sealants, decorative finishes, accessory products such as trim, tiles, decorative finishings, etc).

One embodiment provides a computer system including a web server configured to deliver a web based interface to a plurality of user terminals, wherein the web server is configured to perform a method as described herein.

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer program product configured for allowing the performance of a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 schematically illustrates a product information framework according to one embodiment.

FIG. 2A illustrates a method according to one embodiment.

FIG. 2B illustrates a method according to one embodiment.

FIG. 2C illustrates a method according to one embodiment.

FIG. 2D illustrates a method according to one embodiment.

FIG. 2E illustrates a method according to one embodiment.

FIG. 3 provides a system level overview according to one embodiment.

FIG. 4A provides an exemplary screenshot from a web page delivered according to one embodiment.

FIG. 4B provides an exemplary screenshot from a web page delivered according to one embodiment.

FIG. 4C provides an exemplary screenshot from a web page delivered according to one embodiment.

FIG. 4D provides an exemplary screenshot from a web page delivered according to one embodiment.

FIG. 4E provides an exemplary screenshot from a web page delivered according to one embodiment.

FIG. 4F provides an exemplary screenshot from a web page delivered according to one embodiment.

FIG. 4G provides an exemplary screenshot from a web page delivered according to one embodiment.

FIG. 4H provides an exemplary screenshot from a web page delivered according to one embodiment.

### DETAILED DESCRIPTION

Described herein are systems and methods for providing product information. By way of example, embodiments include computer implemented technologies for delivering information related to building and construction products. Embodiments of the invention have been particularly developed for providing users with access to information including, but not limited to, the likes of fire/acoustic rating information, environmental rating information, and warranty information. Whilst some embodiments will be described herein with particular reference to that application, it will be appreciated that the invention is not limited to such a field of use, and is applicable in broader contexts.

### General Framework

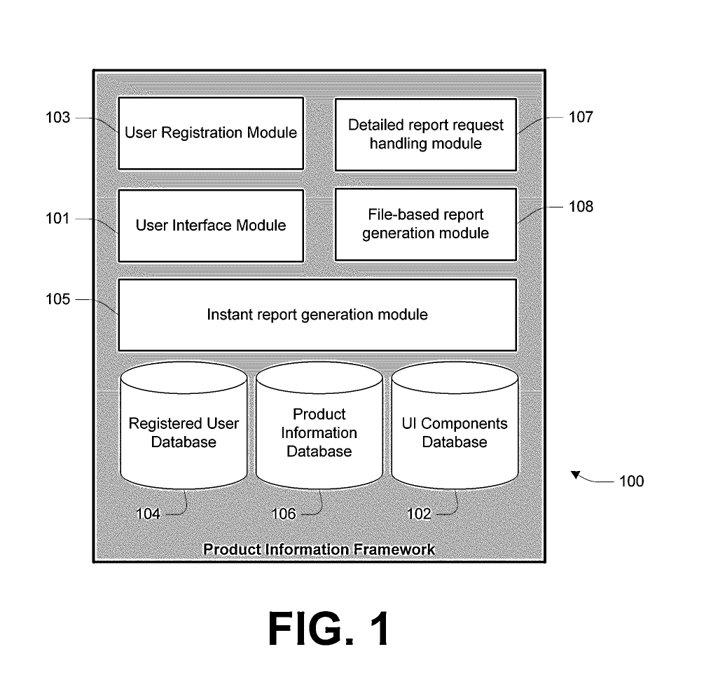

FIG. 1 provides a schematic overview of a product information framework 100. This framework is conceptually split into a number of logical components, which need not be physically separated. For example, these components may be collectively provided by one or more software applications executing on one or more computing platforms (optionally distributed platforms). It should be appreciated that not all of these logical components are present in all embodiments.

Framework 100 includes user interface module 101, which in conjunction with a User Interface (UI) components database 102 provide data and logic for driving a user interface. For example, this user interface may be web-delivered for rendering within a client web-browser application, as discussed further below. From a functional standpoint, the user interface module provides the requisite functionalities for displaying information to a user, and for receiving input from a user.

A user registration module 103 operates in conjunction with a registered user database 104 for providing a process whereby a user registers to use framework 100. For example, a user provides various aspects of personal information, and is associated in database 104 with a username and password thereby to allow identification of the user. In some embodiments there are multiple classes of user, with varied ranges of functionalities being available to the various classes of user.

An instant report generation module 105 operates in conjunction with a product information database thereby to provide a user with product information based on requests and information submitted via the user interface components. Reports generated by module 105 are delivered to a user via user interface module 101. The present framework is also configured for receiving and progressing requests for more detailed reports, which require manual or third party intervention for their generation, via a detailed report request handling module 107. Additionally, a file-based report generation module 108 is provided for generating reports (such as PDF reports) for delivery to a user (for example by download or email).

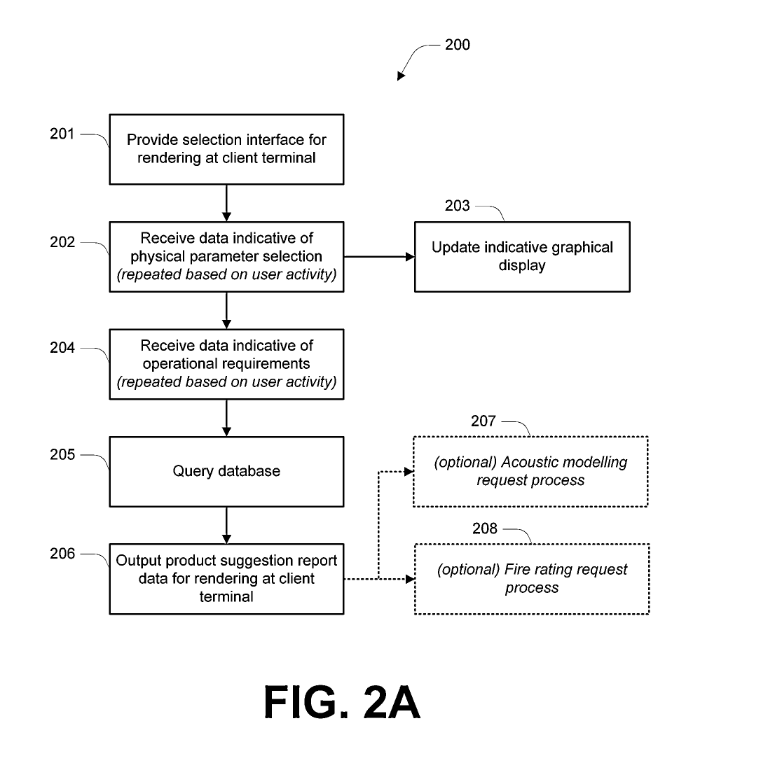

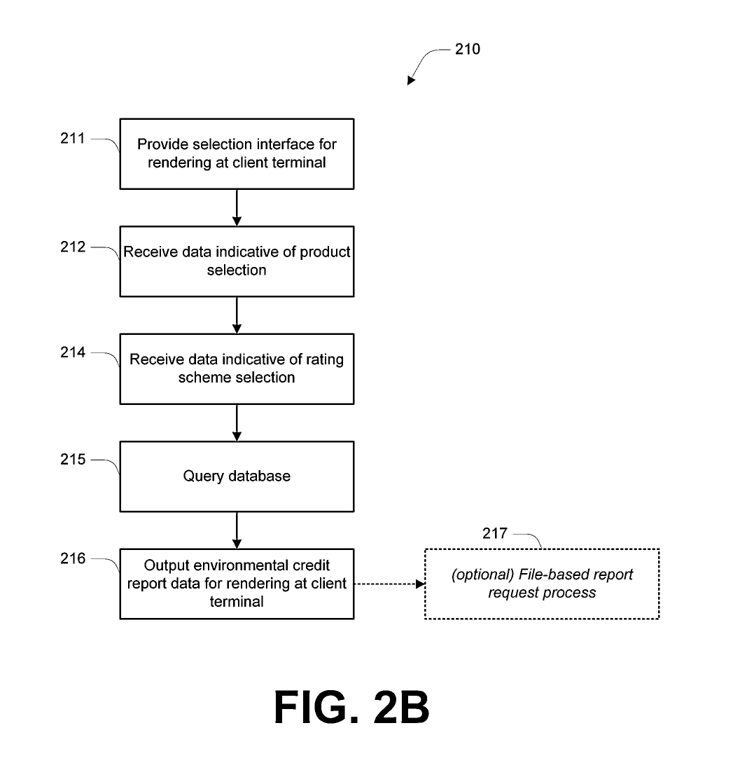

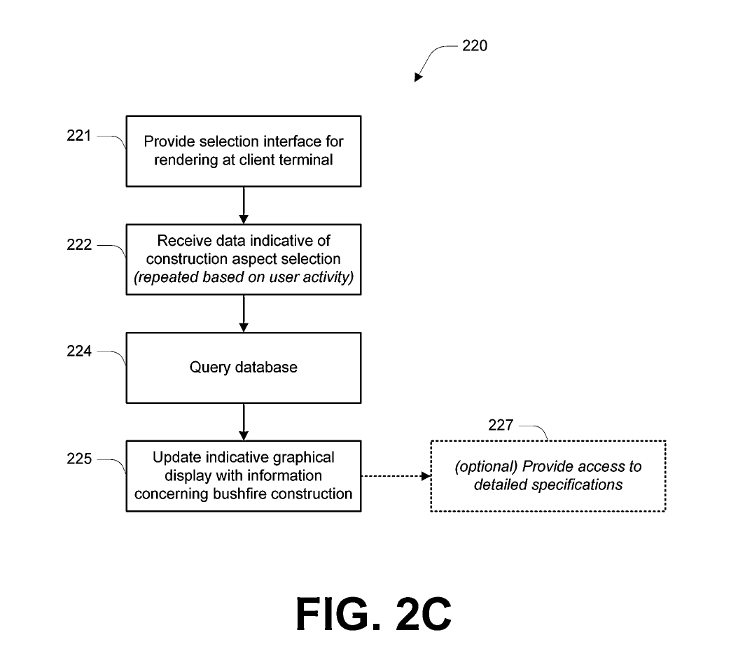

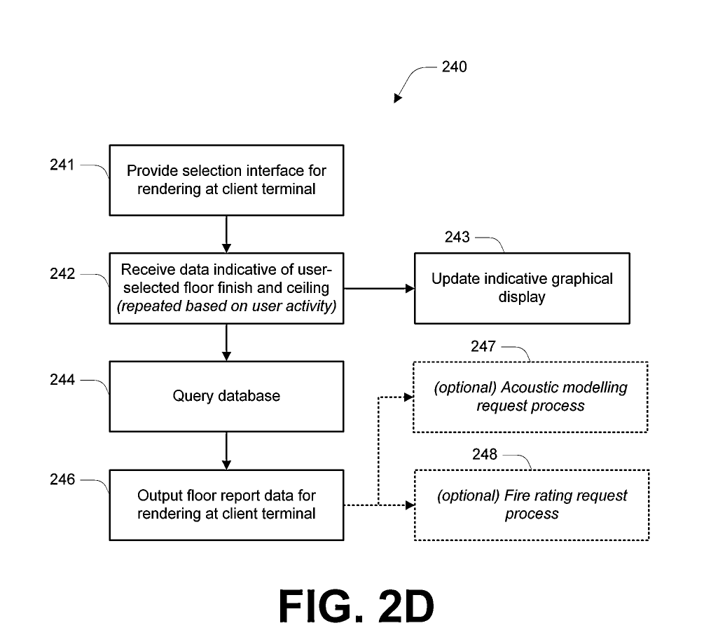

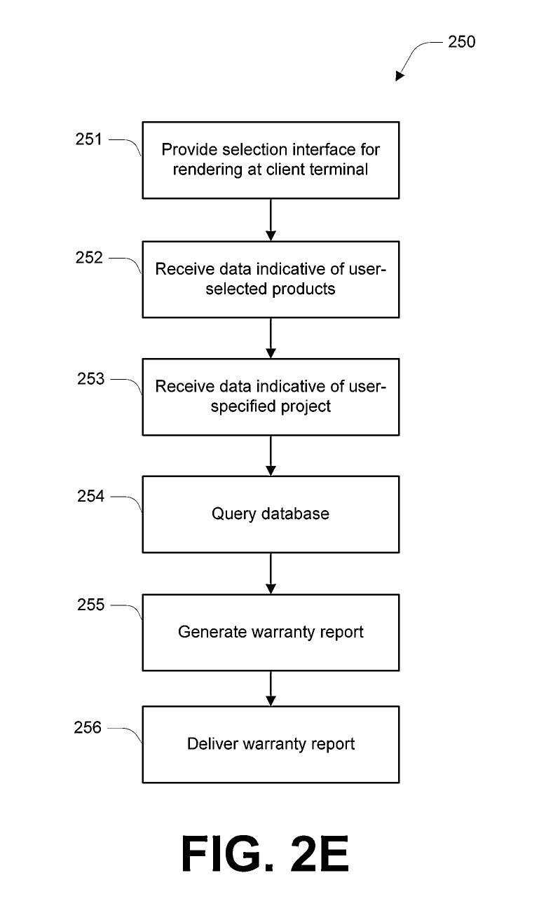

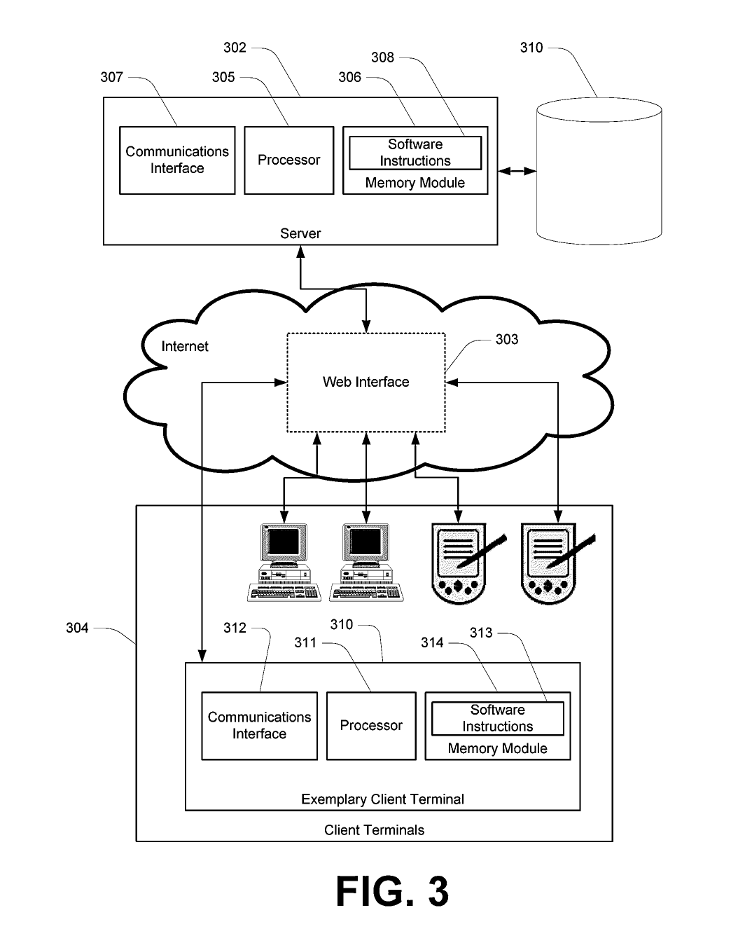

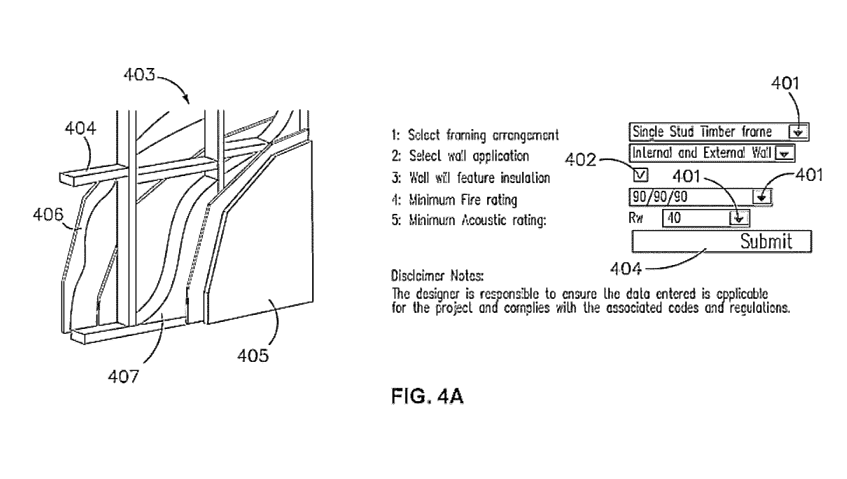

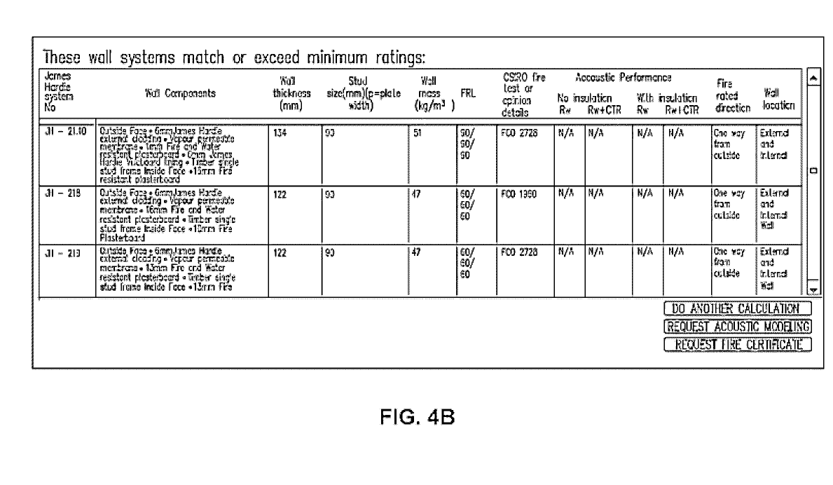

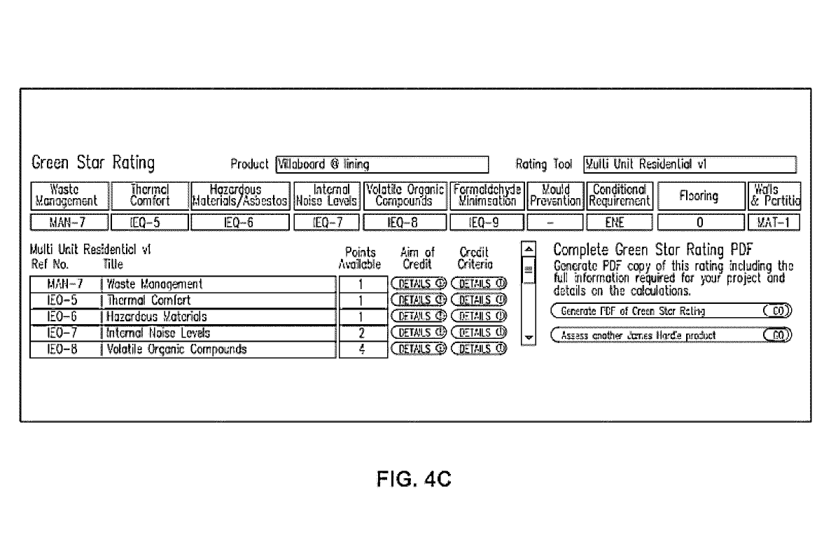

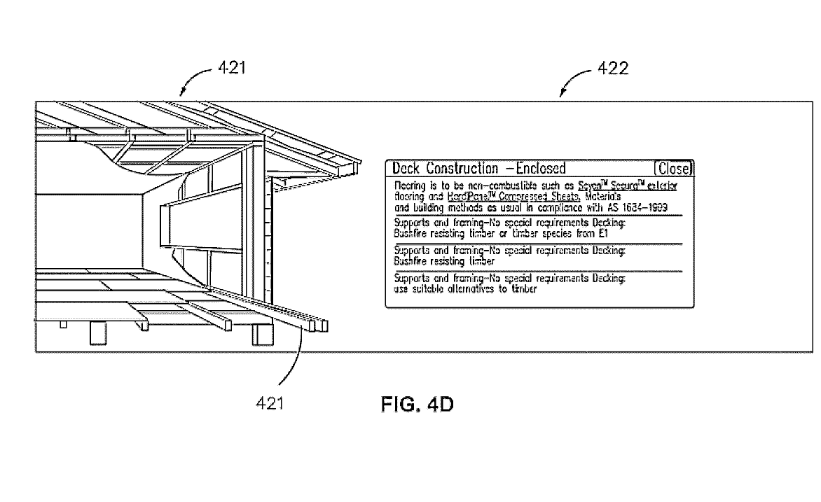

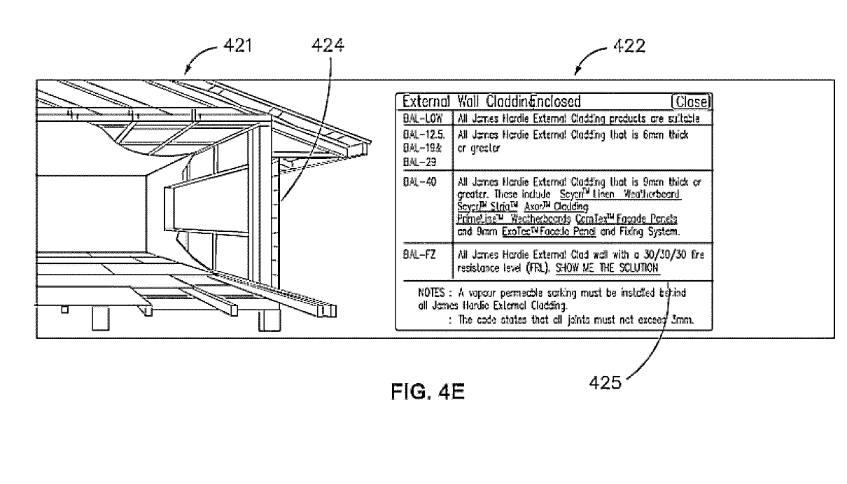

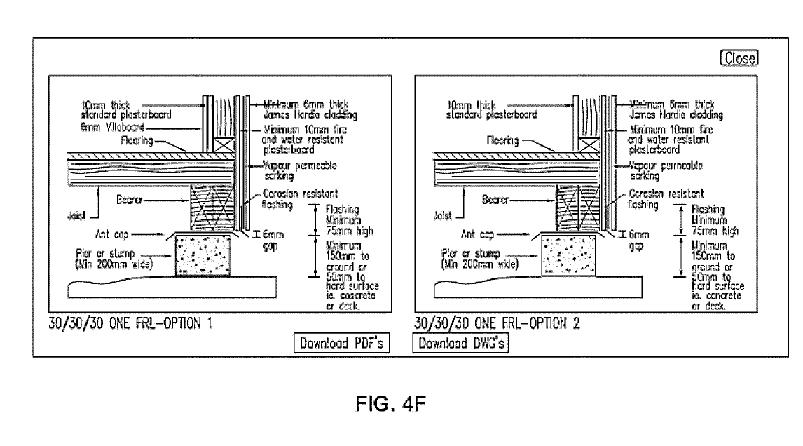

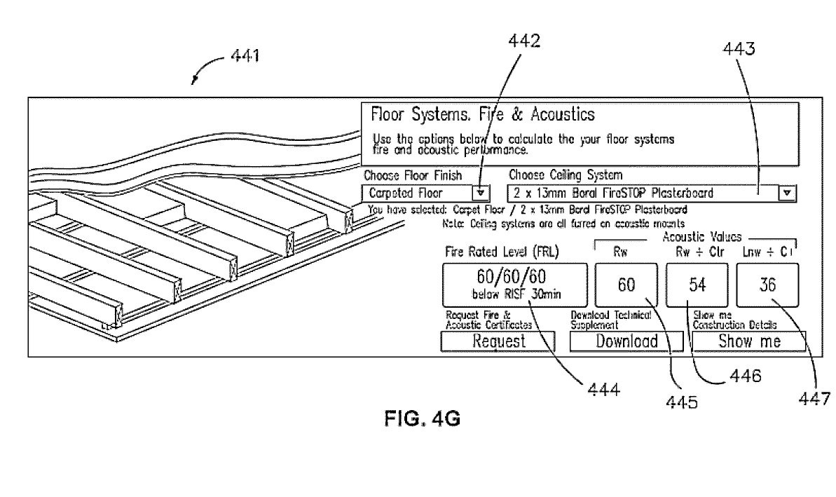

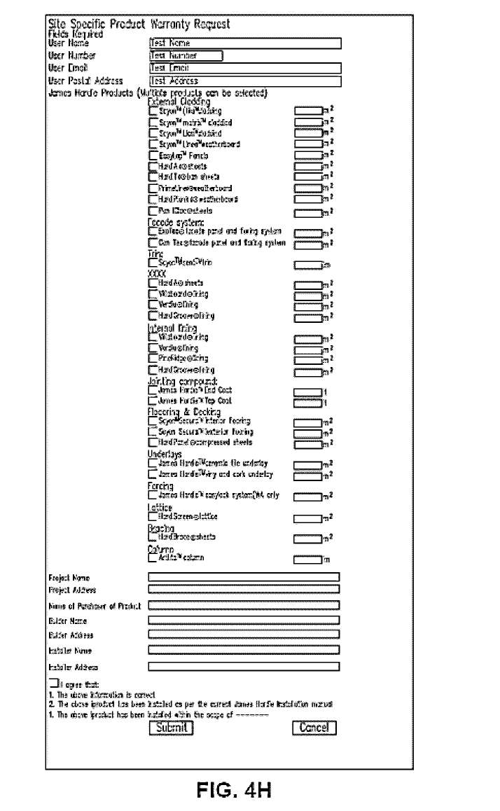

Various examples of functionalities performed in the context of delivering product information via framework 100 are discussed further below. In particular, FIG. 2A to FIG. 2E illustrate exemplary methods, FIG. 3 illustrates an exemplary system for the delivery of information to users via such methods, and FIG. 4A to 4H provide exemplary screenshots generated by the execution of such methods in the context of a web interface.

### Fire/Acoustics Selection Tool

FIG. 2A illustrates a method 200 for providing information relating to products for the construction of walls. In very broad terms, the present method assists a user identify appropriate products based on user-specified physical parameters and operational requirements. This method is optionally delivered via framework 100 in a web-based arrangement such as that discussed further below by reference to FIG. 3.

Step 201 includes providing an interface for receiving data indicative of a set of physical parameters for a structural assembly, and data indicative of one or more operational requirements for that structural assembly. In the present embodiment the structural assembly is a wall, but other structural assemblies (such as floors, roofs, decks and the like) may be present in further embodiments. The physical parameters are a framing arrangement (e.g. stud configuration and frame material), wall application (e.g. “both sides internal”, “both sides external”, or “one side internal/one side external”), and presence of wall insulation. The operational requirements include a minimum fire rating and a minimum acoustic rating. The minimum fire rating is in some embodiments based on Fire Resistance Level as defined in the Building Code of Australia, which defines a grading period in minutes for structural adequacy, integrity and insulation. The minimum acoustic rating is optionally defined using Building Code of Australia standards, with measurements based on sound reduction index and airborne/impact sound values (i.e. Rw and Rw+Ctr). However, it will be appreciated that other protocols for fire/acoustic rating may be used, for example protocols recognized in a jurisdiction of interest (such as a regional/local/national protocol or standard). In some embodiments processing is performed thereby to determine the location of a client/job, and identify appropriate standards or protocols based on that location.

The specific manner by which the interface is provided varies between embodiments. By way of example, FIG. 4A provides a particular screenshot rendered in a web-browser. The implementation shown in the screenshot of FIG. 4A includes a plurality of drop down menus 401 and a check-box 402.

Step 202 includes receiving data indicative of selection of a physical parameter. For example, in the context of FIG. 4A, a user has manipulated a drop-down menu to select an option of “single stud timber frame”. This results in a postback event by which data indicative of the user selection (which occurs at the user's local terminal) is back-propagated to the web server. Step 202 is repeated at the discretion of the user. That is, each time the user makes a selection of a physical parameter, step 202 is repeated.

In the present embodiment, each time step 202 is performed, that triggers a process 204 for the updating of a graphical display, such as display 403 of FIG. 4A. Display 403 is configured to provide a visual representation, preferably a partial cut away view, of a wall having the selected physical parameters. Each time a user selects a different physical parameter, the image is modified accordingly. In the case of FIG. 4A, display 403 shows a wall having a single stud timber frame 404, an internal side 405, an external side 405, and insulation 406.

Step 204 includes receiving data indicative of selection of operational requirements. Much like step 203, this is triggered by user manipulation of drop down menus and the like, and is repeated depending on user activity.

Step 205 includes querying a repository of product information thereby to identify a building solution satisfying the set of physical parameters and one or more operational requirements for that structural assembly. This leads to step 206, which in turn includes providing output for allowing the display of a report indicative of the building solution. This output presently takes the form of data for rendering in a web browser at a client terminal thereby to provide a rendering of the report for viewing by a user of the client terminal. FIG. 4B provides an example of such a report. This report details sets of wall components that, when used together, meet the user's specifications. Additional information, such as wall thickness and mass, is provided for each set of wall components.

The user is provided with options to request an acoustic modeling report at step 207 or a fire rating report (for example a fire certification document) at step 208 for a wall using a selected set of components. In the context of the former, a user is invited to provide various project details, including a project name/address, total wall lining area, and information concerning the wall configuration that is to be acoustically modeled. In the context of the latter, a user is invited to provide various project details, including a project name/address, and a total wall/floor area. In terms of framework 100, such reports are generated using module 407, and delivered electronically (e.g. via email) to the requesting user.

With the wide range of products available for wall components, and inherent complications in understanding fire rating and acoustic modeling issues, the above embodiment provides useful assistance to designers, builders, and the like. Furthermore, for a manufacturer or supplier of such products, it provides a useful competitive advantage.

In some embodiments additional/other operational requirements are considered, such as earthquake rating, storm rating, cyclone rating, and the like. It will be appreciated that the present disclosure should not be necessarily limited to any particular form of operational requirements.

### Environmental Rating Report Generation Tool

FIG. 2B illustrates a method 210 for providing information relating to products for the construction of walls. In very broad terms, the present method assists in product selection in light of environmental rating concerns, and provides reports on environmental rating information for particular products. Once again, this method is optionally delivered via framework 100 in a web-based arrangement such as that discussed further below by reference to FIG. 3.

Step 211 includes providing an interface for receiving data indicative of one or more user-selected construction products. These products may fall into a wide range of categories, including (but not limited to) cladding, trim, weatherboard, façade, paints, coatings, flooring, underlay, and linings. The interface provided at step 211 may include a selection interface for designating a category. However, the present embodiment is primarily concerned with the selection of a particular product, rather than product category. For example, a user may select a specific cladding product, optionally identified by a trademark or the like. Data indicative of a user's product selection is received at step 212. For example, a user manipulates a GUI element such as a drop-down menu or check box to select a desired product. This results in a postback event (or allows for a later postback event) by which data indicative of the user selection (which occurs at the user's local terminal) is back-propagated to the web server.

Step 214 includes receiving data indicative of a selection of a predetermined environmental rating protocol. This may be a two-tier process, whereby a user first selects a general environmental rating protocol (such as the Green Star rating scheme (managed by the Green Building Council of Australia), and subsequently selects a specific sub-protocol within that general protocol (for example the Green Star rating scheme includes sub-protocols for healthcare, office, industrial, education, and so on). In some embodiments only the second tier is performed (i.e. the general protocol is pre-designated). Once again, this selection is made by a user via manipulation of GUI elements.

Step 215 includes querying a repository of product information thereby to identify rating data for the one or more user-selected construction products based on the selected environmental rating protocol. For example, this repository associates data specific to the rating protocol with each selectable product. Step 216 then provides output for allowing the display of a report indicative of the rating data for display in the client terminal web browser. An exemplary report is provided in FIG. 4C, being a report for Villaboard® lining under Green Star Multi Unit Residential V1. The report shows the various credit points available, and provides access to additional information regarding the reasoning and criteria under which those points are made available. A user may optionally request a file-based report (for example a PDF document) providing this information at step 217.

The present approach greatly simplifies understanding of Green Star requirements (and/or optionally the requirements of other rating protocols), and serves as a useful marketing tool for a manufacturer or supplier of construction products. That is, by providing environmental rating information in a simple product-specific form, there is provided encouragement for a consumer to use those products.

### Bushfire Construction Information Tool

FIG. 2C illustrates a method 220 for providing information relating to products in the context of construction mindful of bushfire conditions. In very broad terms, the present method assists in product selection in light of bushfire concerns, and provides advice on particular products, and the manner in which they should be used, to address such concerns. Once again, this method is optionally delivered via framework 100 in a web-based arrangement such as that discussed further below by reference to FIG. 3.

Step 221 includes providing an interface for receiving data indicative of a product category. More specifically, the interface allows user selection of a construction aspect selection, such as walls, floors, decking, or the like. In the present embodiment the interface includes a diagrammatic representation of a dwelling, and selections are made at step 222 by manipulating a cursor over that diagrammatic representation. For example, exemplary screenshots are provided in FIG. 4D and FIG. 4E, which shows a region 421 for displaying the diagrammatic representation, and a region 422 for displaying fire-related product information. When a user manipulates the cursor to a particular region of the representation (and in some cases clicks a mouse button), that triggers step 224, which includes querying a repository of product information thereby to identify fire-related product information for the selected construction aspect, and data for an updated graphical display is delivered at step 225. For instance, in the context of FIG. 4D the user manipulates the cursor to point 423 and is provided with product information for internal decking, and in the context of FIG. 4D the user manipulates the cursor to point 424 and is provided with product information for external wall cladding.

In some embodiments method 220 includes providing diagrammatic specifications for the installation of a predetermined set of products (step 227). An example of this is provided in the screenshot of FIG. 4F, which shows information accessed via region 425 in FIG. 4E.

### Floor System Fire/Acoustic Rating Information Tool

FIG. 2D illustrates a method 240 for providing product information in the context of fire and/or acoustic ratings for a floor system. To this end, in some embodiments the method applies to both fire rating information and acoustic rating information, whilst in other embodiments the method applies to only one of fire rating information and acoustic rating information. Once again, this method is optionally delivered via framework 100 in a web-based arrangement such as that discussed further below by reference to FIG. 3.

Step 241 includes providing an interface for receiving data indicative of user-selected a floor finish and a user-selected floor ceiling. For example, this interface allows a user to manipulate GUI elements such as a drop-down menus or check boxes to select a floor finish (for example tiled or carpeted) and floor ceiling (for example from a selection of potential products, which may include plasterboard products). This results in a postback event (or allows for a later postback event) by which data indicative of the user selection (which occurs at the user's local terminal) is back-propagated to the web server. Data indicative of selections is received at step 242.

In the present embodiment, upon selection of a floor finish and floor ceiling at step 242, step 243 includes updating a graphical display thereby to provide the user with a diagrammatic representation of a floor system having the selected features. This includes identifying, in a repository of image data, image data for displaying a representation of a floor system using the user-selected floor finish and user-selected floor ceiling, and providing output for allowing the display of an image based on that image data via the interface. For example, the exemplary screenshot of FIG. 4G shows a representation 441 floor system having a carpeted finish (selected via GUI element 442) and a specific form of plasterboard ceiling (selected via GUI element 443).

Step 244 includes querying a repository of product information thereby to identify fire rating information and/or acoustic rating information for the combination of the user-selected floor finish and user-selected floor ceiling. Step 245 then includes providing output for allowing the display of a report indicative of the fire rating information and/or acoustic rating information for the combination of the user-selected floor finish and user-selected floor ceiling. This is shown in FIG. 4G, which shows a fire rating 444, and acoustic rating values 445, 446 and 447.

The user is provided with options to request an acoustic modeling report at step 247 or a fire rating report (for example a fire certification document) at step 248 for a flooring arrangement using a selected set of components. In terms of framework 100, such reports are generated using module 407, and delivered electronically (e.g. via email) to the requesting user.

Method 240 provides a useful tool for assisting a designer or builder in selected an appropriate floor system for a specific project. Furthermore, it provides a useful marketing tool for a manufacturer or supplier of flooring system products.

### Warranty Information Generation Tool

FIG. 2E illustrates a method 250 for providing warranty information in respect of one or more user-selected products information, tailored to a specific project. Once again, this method is optionally delivered via framework 100 in a web-based arrangement such as that discussed further below by reference to FIG. 3.

Step 251 includes providing an interface for receiving data indicative of one or more user-selected construction products, and data indicative of a user-nominated project using the one or more user-selected construction products. For example, this interface includes GUI elements such as a drop-down menus, value fields and check boxes. In one embodiment, a user selects a set of products that are to be used in the context of a project, and also designates a quantity for each product (being a measurement in linear meters, square meters, liters, or another appropriate quantifier for a particular product).

The data indicative of a user-nominated project includes a project name, address, builder, installer and purchaser (although in other embodiments additional or fewer aspects of data are included). The crux is to provide sufficient information to identify a project, so that a project-specific warranty report may be generated.

Data indicative of the one or more user-selected construction products, and data indicative of the user-nominated project using the one or more user-selected construction products, is received at 252 and 253 respectively. Step 254 includes querying a repository of product information thereby to identify warranty data for the one or more user-selected construction products. With this information, output is provided at 255 for allowing the display of a report indicative warranty information for the user-nominated project. In the present embodiment the report is a file-based report in PDF generated using a PDF creation module. The report is delivered to the user (either by email or by file download) at 256.

The one or more user-selected construction products fall into any one or more of the following categories: cladding, trim, weatherboard, façade, paints, coatings, flooring, underlay, eaves, joining compounds, ducting, fencing, lattice, columns and linings. It will be appreciated that this is not by any means an exclusive list. FIG. 4H provides an exemplary screenshot from an interface according to one embodiment.

In some embodiments, the construction products available for selection all originate from a common source, for example a common manufacturer or supplier. It will be appreciated that this is primarily the case in situations where framework 100 is provided on behalf of such a manufacturer or supplier. However, in other cases a single party is responsible for providing warranty reports for products originating from a variety of different sources. For example, such a party maintains warranty information for a plurality of distinct manufacturers or suppliers, and is authorized to provide warranty reports for those parties.

In some embodiments the report includes one or more certifications to be verified by one or more of a builder and an installer. For example, the certifications may include:
That the user-specified product information is correct.
That the above products have been installed as required by the manufacturer (for example based on a current installation manual).
That the products have been installed within the scope of recommendations made by the manufacturer.

The crux of these certifications is to provide on the report conditions that apply to a builder/installer that have potential to impact on warranty validity. That is, warranty information in the repository of product information is only accurate for a particular project on the assumption that these certifications are validated.

In the present embodiment, the generated report includes details of a project, the products supposedly used in that project, and details of the warranty applying to these products. A builder/installer then verifies certifications (for example by signing the report). In this manner, a builder is able to quickly and conveniently generate warranty information for a project, by leveraging information maintained and delivered by a manufacturer or supplier of products used in the course of that project.

### Exemplary System-Level Overview

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310 (which may provide the functionality of any one or more of databases 103, 105 and 106), which in some embodiments includes a plurality of distributed storage locations. In further embodiments the database leverages memory module 306. Database 310 maintains a data indicative of employer profiles and jobseeker profiles (including data for allowing the viewing of both public and private profiles).

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein.

The invention is not limited to any particular programming language or operating system.

### CONCLUSIONS

It will be appreciated that the disclosure above provides various novel and inventive systems and methods for providing product information. It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for providing product information, the method including the steps of:
providing an interface for receiving data indicative of:
(i) a set of physical parameters for a structural assembly; and
(ii) one or more operational requirements for that structural assembly, wherein the one or more operational requirements include either or both of fire rating requirements and acoustic rating requirements;
querying a repository of product information thereby to identify a building solution, including a specified set of construction components, which satisfies the set of physical parameters and one or more operational requirements for the structural assembly; and
providing output for allowing the display of a report indicative of the building solution.

2. A method according to claim 1 wherein the set of physical parameters includes any one or more of a framing arrangement for a wall, a wall application, and presence of wall insulation.

3. A method according to claim 2 including:
for one or more of the physical parameters, identifying image data for displaying a representation of a wall having those physical parameters; and
providing output for allowing the display of an image based on that image data via the interface.

4. A method according to claim 1 wherein the one or more operational requirements include fire rating requirements.

5. A method according to claim 1 wherein the one or more operational requirements include acoustic rating requirements.

6. A method according to claim 2 wherein the report includes characteristics of a wall constructed using the specified set of wall components.

7. A method according to claim 1 wherein the report includes an acoustic modelling report.

8. A method according to claim 1 wherein the report includes a fire rating report.

9. A method according to claim 1 wherein the report includes an environmental rating report.

10. A method according to claim 1 wherein the report includes a warranty report indicative of warranty information for a user of the building solution.

11. A computer system including a web server configured to deliver a web based interface to a plurality of user terminals, wherein the web server is configured to perform a method according to claim 1.

12. A computer system including a microprocessor configured to perform a method according claim 1.

13. A tangible non-transient computer readable medium carrying executable code that when executed on one or more microprocessors of a computer system cause the computer system to perform a method according to claim 1.

14. A computer program product configured for allowing the performance of a method according to claim 1.
